(19) United States
(12) Patent Application Publication
(10) Pub. No.: US 2012/0229458 A1
(43) Pub. Date: Sep. 13, 2012

(54) IMAGE CONTROL DEVICE

(76) Inventors: Ching-Sheng CHENG, Nantou County (TW); Hsu-Jung Tung, Hsinchu County (TW); Wen-Chi Lin, Yunlin County (TW)

(21) Appl. No.: 13/414,429

(22) Filed: Mar. 7, 2012

(30) Foreign Application Priority Data
Mar. 10, 2011 (TW) 100108032

(51) Int. Cl. G06F 3/01; G06T 15/00

(52) U.S. Cl. 345/419

(57) ABSTRACT

An image control device is disclosed, which may be cooperated with a display device. The display device may cooperates with a pair of glasses and present a first image frame, a second image frame, a third image frame, and a fourth image frame sequentially. A first lens of the glasses is non-opaque when the display device presents the first and the third image frames. A second lens of the glasses is non-opaque when the display device presents the second and the fourth image frames. The image control device comprises an input end for receiving light-sensing signals from one or more sensors, and a signal processing device for configuring the transparency of the lenses and/or for configuring the duration in which the first lens and/or the second lens is non-opaque according to the light sensing signals.

### CROSS-REFERENCE TO RELATED APPLICATIONS

This application claims the benefit of priority to Taiwanese Patent Application No. 100108032, filed on Mar. 10, 2011; the entirety of which is incorporated herein by reference for all purposes.

### BACKGROUND

The present disclosure generally relates to image control devices and, more particularly, to the image control devices which may reduce the brightness difference when the user observes the images.

Three dimensional (3D) display devices bring the extraordinary viewing experience and therefore are widely accepted by the consumers. The 3D display devices may provide 3D images with various stereoscopic technologies. For example, the 3D display devices may cooperate with specific designed glasses so that the left eye and the right eye of the viewer may observe different images. The images are combined in the viewer's brain and give the perception of 3D images. For example, the display device may cooperate with the polarized glasses, shutter glasses, etc.

When the display device cooperates with the shutter glasses, the display device alternately presents the image frames for the left eye and the right eye of the viewer and the shutter glasses correspondingly block the right eye and left eye. Thus, the viewer may observe the corresponding image frames for the left eye and the right eye. For example, when the display device presents the images for the left eye, the glasses let the left eye of the viewer observe the images and block the right eye of the viewer. When the display device presents the images for the right eye, the glasses let the right eye of the viewer observe the images and block the left eye of the viewer. Thus, the viewer may perceive 3D images.

The lens of the shutter glasses may be configured to block or pass the light. For example, a liquid crystal layer may be configured on the shutter glasses. The liquid crystal layer becomes opaque when the applied voltage is greater than a threshold and becomes non-opaque (e.g., transparent or translucent) when the applied voltage is less than the threshold. Besides, the shutter glasses are synchronized with the 3D display device so as to block or pass the light through the corresponding lenses when the 3D display device alternately presents the images for the left eye and the right eye.

Because the left lens and the right lens of the shutter glasses become non-opaque at different point of time, the viewer usually perceives different degree of brightness due to the variation of the ambient light. The variation of the brightness severely deteriorates the viewing quality and even makes the viewer to feel uncomfortable.

### SUMMARY

In view of the foregoing, it may be appreciated that a substantial need exists for methods and apparatuses that can mitigate or reduce the problems above.

An example embodiment of an image control device for coupling with a display device, wherein the display device may cooperate with a pair of glasses, comprising: a first input end for receiving light-sensing signals from one or more sensors; a second input end for coupling with an image frame conversion device; and a signal processing device for configuring the image frame conversion device to convert a plurality of first image data of a first display frequency into a plurality of second image data of a second display frequency according to the light-sensing signals, and for configure the display device to sequentially display a first, a second, a third, and a fourth image frames of the second image data with the second display frequency; wherein a first lens of the glasses is non-opaque when the display device presents the first and the third image frames respectively in a first period and in a third period, and a second lens of the glasses is non-opaque when the display device presents the second and the fourth image frames respectively in a second period and in a fourth period.

Another example embodiment of an image control device for coupling with a display device, wherein the display device may cooperate with a pair of glasses for sequentially displaying a first, a second, a third, and a fourth image frames, a first lens of the glasses is non-opaque when the display device presents the first and the third image frames respectively in a first period and in a third period, and a second lens of the glasses is non-opaque when the display device presents the second and the fourth image frames respectively in a second period and in a fourth period, comprising: an input end for receiving light-sensing signals from one or more sensors; and a signal processing device for configuring the first lens and/or the second lens according to the light-sensing signals so that a first interval between the first period and the second period and a second interval between the second period and the third period are different.

Another example embodiment of an image control device for coupling with a display device, wherein the display device may cooperate with a pair of glasses for sequentially displaying a first and a second image frames, a first lens of the glasses is non-opaque when the display device presents the first image frame in a first period, and a second lens of the glasses is non-opaque when the display device presents the second image frame in a second period, comprising: an input end for receiving light-sensing signals from one or more sensors; and a signal processing device for configuring the brightness of a light source of the display device according to the light-sensing signals so that the brightness of the light source in the first period is different from the brightness of the light source in the second period.

It is to be understood that both the foregoing general description and the following detailed description are example and explanatory only and are not restrictive of the invention, as claimed.

### BRIEF DESCRIPTION OF THE DRAWINGS

FIG. 1 shows a simplified block diagram of an example image system;

FIG. 2 shows a simplified timing diagram of an example brightness value of the ambient light;

FIG. 3 shows a simplified timing diagram of another example brightness value of the ambient light; and

FIG. 4 shows a simplified timing diagram of another example brightness value of the ambient light, all arranged in accordance with at least some embodiments of the present disclosure described herein.

### DETAILED DESCRIPTION

Reference will now be made in detail to embodiments of the invention, which are illustrated in the accompanying drawings. The same reference numbers may be used throughout the drawings to refer to the same or like parts or components/operations. Certain terms are used throughout the description and the claims to refer to particular components. As one skilled in the art will appreciate, a component may be referred by different names. This disclosure does not intend to distinguish between components that differ in name but not in function. In the description and in the claims, the term “comprise” is used in an open-ended fashion, and thus should be interpreted to mean “include, but not limited to . . . .” Also, the phrase “coupled with” is intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

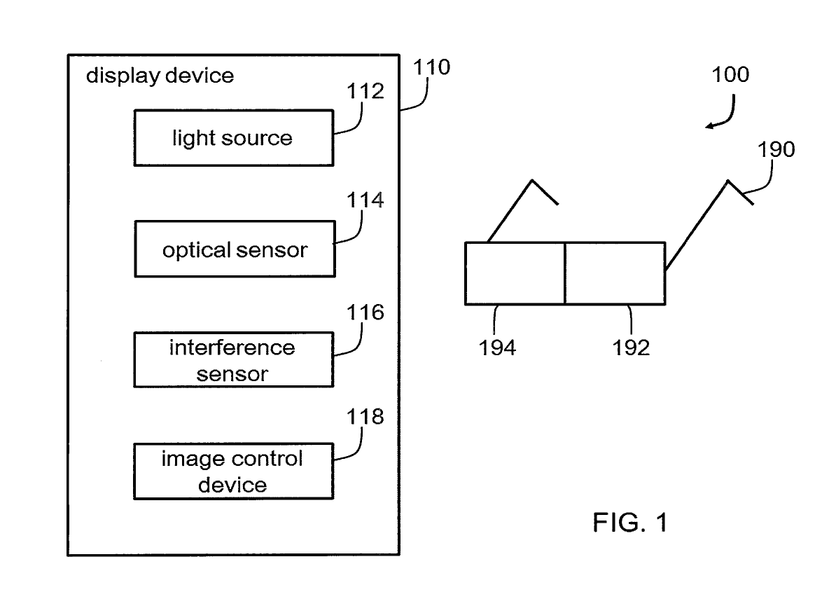

FIG. 1 shows a simplified block diagram of an example image system 100, arranged in accordance with at least some embodiments of the present disclosure. The image system 100 comprises a display device 110 and a pair of glasses 190. The display device 110 comprises a light source 112, an optical sensor 114, an interference sensor 116, and an image control device 118. The glasses 190 comprise a left lens 192 and a right lens 194.

The display device 110 may present images to the viewers and may be realized with CRT devices, image projecting devices, flat panel display devices, etc. When providing 3D images, the display device 110 provides image frames respectively for the left eye and the right eye of the viewer at different period of time. For simplicity, the image frames for the left eye and the right eye of the viewer are referred as the left image frames and the right image frames, respectively. Accordingly, the glasses 190 block the left eye and right eye of the viewer at suitable time by alternately shuttering the left lens 192 and the right lens 194. The lenses 192 and 194 therefore appear non-opaque (e.g., transparent or translucent) and opaque alternately so that the viewer may perceive 3D images.

The light source 112 of the display device 110 provides the required brightness of the images frames so as to be observed by the viewer. For example, the light source 112 may be the lamp of the image projector, the backlight module of the flat panel display, organic light-emitting diodes, or other suitable illumination devices. The light source 112 may be realized with one or more illumination devices, and may be configured inside and/or outside the display device 110.

The optical sensor 114 is used to detect the brightness of the ambient light in the proximity of the display device 110 and/or the viewer. The optical sensor 114 may be realized with the photosensitive device, e.g., the photo-resistor and the photodiode. The optical sensor 114 receives the ambient light in the proximity of the display device 110 and/or the viewer, and generates corresponding output signal as the estimation of the brightness of the ambient light in the proximity of the display device 110 and/or the viewer. In other embodiments, the output signals of the optical sensor 114 are processed by the signal processing device (e.g., the rectifying circuit, the accumulating circuit, and the averaging circuit) so as to be used as the estimation of the ambient light in the proximity of the display device 110 and/or the viewer.

There may still be other interferences which cause the brightness variation of the ambient light in the proximity of the display device 110 and/or the viewer, and the interference sensor 116 is used to detect these interference signals. For example, the AC power source provides the alternative current to the lamps around the display device 110 at a predetermined frequency (e.g., 50 Hz or 60 Hz). The lamps around the display device 110 and the brightness of the ambient light, therefore, may flicker with the predetermined frequency or with multiple of the predetermined frequency (e.g., 100 Hz or 120 Hz). In this embodiment, the interference sensor 116 receives the AC power signal and generates corresponding output signal as the estimation of the brightness of the ambient light in the proximity of the display device 110 and/or the viewer.

In this embodiment, the optical sensor 114 and/or the interference sensor 116 continuously detect the brightness of the ambient light in the proximity of the display device 110 and/or the viewer. In other embodiment, the optical sensor 114 and/or the interference sensor 116 only detect the brightness of the ambient light in the proximity of the display device 110 and/or the viewer at specific time.

In this embodiment, the display device 110 comprises both the optical sensor 114 and the interference sensor 116. In another embodiment, the display device 110 only comprises one of the optical sensor 114 and the interference sensor 116. In still another embodiment, the estimation of the optical sensor 114 and/or the estimation of the interference sensor 116 are provided to the image control device 118 for further processing. In yet another embodiment, the estimation of the optical sensor 114 and the estimation of the interference sensor 116 are combined with suitable weighting and provided to the image control device 118 for further processing.

The image control device 118 receives the estimation of the optical sensor 114 and/or the estimation of the interference sensor 116 for determining whether the brightness variation of the ambient light between the left image frames and/or the right image frames is greater than a predetermined value. The image control device 118 may also adopt one or more suitable mechanisms for tracking or predicting the brightness variation of the ambient light according to the estimation of the optical sensor 114 and/or the estimation of the interference sensor 116, and for accordingly configuring the light source 112 and/or the glasses 190. For example, an adaptive filter or a phase-locked loop circuit may be coupled with or built in the image control device 118 for receiving the estimation of the optical sensor 114 and/or the estimation of the interference sensor 116 to track or predict the brightness variation of the ambient light.

The image control device 118 may also process the estimation of the optical sensor 114 and/or the estimation of the interference sensor 116 with a suitable signal processing algorithm. The data processed by the image control device 118 may therefore be used to determine the brightness variation of the ambient light by the image control device 118 or other control devices.

The image control device 118 may adopt one or more mechanisms to configure the light source 112 and/or the glasses 190. For example, in one embodiment, the image control device 118 may adjust the brightness of the light source 112, the display frequency of the display device 110, the transparency of the lens 192, the transparency of the lens 194, and/or the intervals in which the lens 192 and/or the lens 194 are non-opaque. Therefore, the brightness variation may be reduced when the viewer observes the left image frames and the right image frames. Furthermore, various signal processing devices may be coupled with or built in the image control device 118 for conducting the above-mentioned adjustment. For example, the image conversion device, the adaptive filter, or the combinational logic circuit may be coupled with or built in the image control device 118 for conducting the determination methods and/or adjustment methods mentioned above.

The left lens 192 and the right lens 194 of the glasses 190 may be realized with optical devices, electrical devices, and/or mechanical devices. The left lens 192 and the right lens 194 may be configured to be opaque or non-opaque at the specific intervals designated by the image control device 118. In some embodiments, when the lenses 192 and 194 are realized with the liquid crystal device, the transparency of the left lens 192 and the right lens 194 may also be configured.

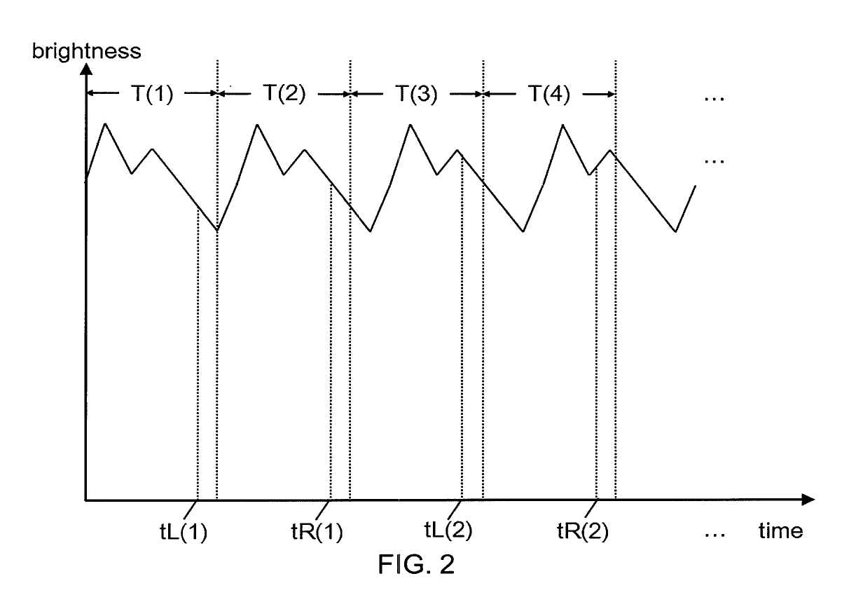

The image control system 100 is further explained below with FIGS. 1-4. FIGS. 2-4 show simplified timing diagrams of several example brightness values of the ambient light. The curves in FIGS. 2-4 represents the brightness values of the ambient light at different point of time according to the estimation of the optical sensor 114 and/or the estimation of the interference sensor 116.

In FIG. 2, the display device 110 presents the left image frames in the intervals T(1), T(3) . . . T(2n+1) and presents the right image frames in the intervals T(2), T(4) . . . T(2n). The left eye of the viewer may observe the left image frames through the left lens 192 during the intervals tL(1), tL(2) tL(n) while the right eye of the viewer is blocked by the right lens 194. The right eye of the viewer may observe the right image frames through the right lens 194 during the intervals tR(1), tR(2) tR(n) while the left eye of the viewer is blocked by the left lens 192. As shown in FIG. 2, when the viewer observes the image frames in the intervals tL(n) and tR(n), the different brightness of the ambient light severely deteriorate the viewing quality. In FIGS. 2-4, the intervals tL(n) and tR(n) are denoted as dots for conciseness. In reality, the intervals tL(n) and tR(n) are configured to be a suitable period of time so that the viewer may observe the image frames.

In this embodiment, the duration of the intervals T(n) is configured to be fixed. The duration between the intervals tL(n) is configured to be fixed. The duration between the intervals tL(n) is referred as the period of the intervals tL(n) for simplicity. The duration between the intervals tR(n) is also configured to be fixed. The duration between the intervals tR(n) is referred as the period of the intervals tR(n) for simplicity. The period of the intervals tL(n), tR(n), or other intervals herein may be calculated from the beginning of one interval to the beginning of the following interval or calculated from the end of one interval to the end of the following interval. For example, when the display device 110 presents the image frames at a frequency of 120 Hz, the intervals T(n), the period of the intervals tL(n), and the period of the intervals tR(n) may be configured as 1/120 second, 1/60 second, and 1/60 second, respectively.

Because the brightness of the ambient light in the intervals tL(n) and tR(n) are different, the image control device 118 may adjust the brightness of the light source 112 so that the viewer may perceive substantially the same brightness when observing the left image frames and the right image frames. The image control device 118 may adopt several mechanisms to adjust the light source 112 according to different design considerations. For example, in one embodiment, the image control device 118 may enhance the brightness of the light source 112 when the estimation of the ambient light is less than the predetermined value. The image control device 118 may also lower the brightness of the light source 112 when the estimation of the ambient light is greater than the predetermined value. In another embodiment, the image control device 118 may lower the brightness of the light source 112 when the estimation of the ambient light is less than the predetermined value. The image control device 118 may also enhance the brightness of the light source 112 when the estimation of the ambient light is greater than the predetermined value. In the above embodiments, the image control device 118 may compare the estimation of the optical sensor 114 and/or the estimation of the interference sensor 116 with one or more predetermined values for adjusting the light source 112.

In another embodiment, the intervals T(n), tL(n), and tR(n), the period of the intervals tL(n), and the period of the intervals tR(n) are configured to be fixed. When the brightness of ambient light in the intervals tL(n) and tR(n) are different, the image control device 118 may adjust the transparency of the lens 192 and/or the transparency of the lens 194 so that the viewer may perceive substantially the same brightness when observing the left image frames and the right image frames. For example, in one embodiment, the image control device 118 may lower the transparency the lens 192 and/or the lens 194 when the estimation of the ambient light is greater than the predetermined value. The image control device 118 may also enhance the transparency the lens 192 and/or the lens 194 when the estimation of the ambient light is less than the predetermined value. In another embodiment, the image control device 118 may configure the brightness of the light source 112 and the transparency of the lenses 192 and 194, cooperatively. For example, when the estimation of the ambient light is greater than the predetermined value, the image control device 118 may enhance the brightness of the light source 112 and lower the transparency of the lenses 192 and 194 so that the viewer may perceive substantially the same brightness when observing the left image frames and the right image frames.

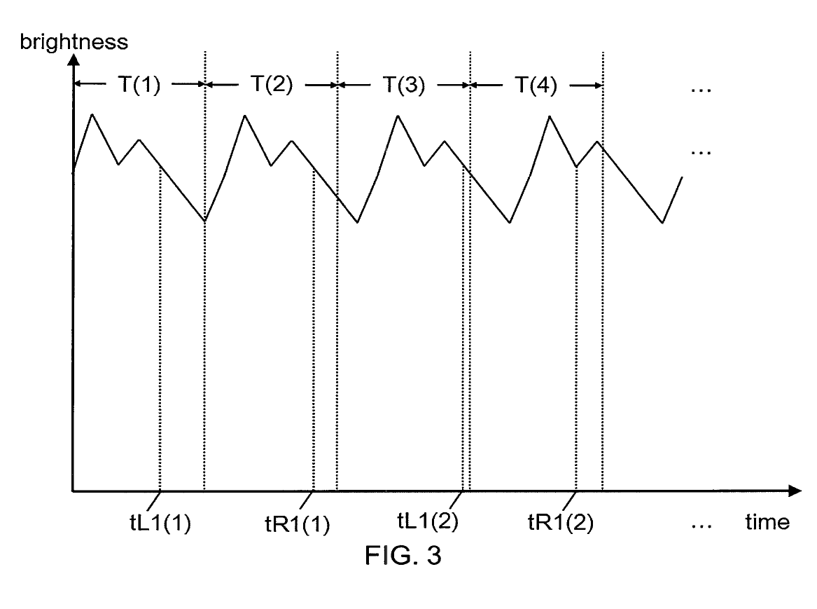

As shown in FIG. 3, in another embodiment, the intervals T(n) is still configured to be fixed. The image control device 118 configures the intervals in which the viewer observes the left image frames to be the intervals tL1(n), and configures the intervals in which the viewer observes the right image frames to be the intervals tR1(n) so that the viewer may perceive substantially the same brightness when observing the left image frames and the right image frames. For example, the image control device 118 may choose the intervals tL1(n) and tR1(n) so that the viewer may perceive substantially the same brightness when the lenses 192 and 194 respectively become non-opaque. In another embodiment, the image control device 118 only configures the intervals tL1(n), or only configures the intervals tR1(n). In another embodiment, the image control device 118 may configure the intervals in which the viewer observes the left image frames and/or the right image frames accompanied with the adjustment of the brightness of the light source 112 and/or the transparency of the lenses 192 and 194 so that the viewer may perceive substantially the same brightness when observing the left image frames and the right image frames. In the embodiment in FIG. 3, the period of the intervals tL1(n) and the period of the intervals tR1(n) are configured to be fixed. In another embodiment, the period of the intervals tL1(n) and the period of the intervals tR1(n) are not configured to be fixed.

When the duration of the lens being non-opaque is longer, the viewer may perceive higher brightness. In another embodiment, the image control device 118 may configure the duration in which the lenses 192 and 194 are non-opaque so that the viewer may perceive substantially the same brightness when observing the left image frames and the right image frames. For example, the image control device 118 may lengthen the duration in which the lens 192 and/or the lens 194 are non-opaque when the estimation of the ambient light is less than the predetermined value. The image control device 118 may also shorten the duration in which the lens 192 and/or the lens 194 are non-opaque when the estimation of the ambient light is greater than the predetermined value. In another embodiment, the image control device 118 may configures the duration in which the lenses 192 and 194 are non-opaque accompanied with other adjustment methods mentioned above so that the viewer may perceive substantially the same brightness when observing the left image frames and the right image frames.

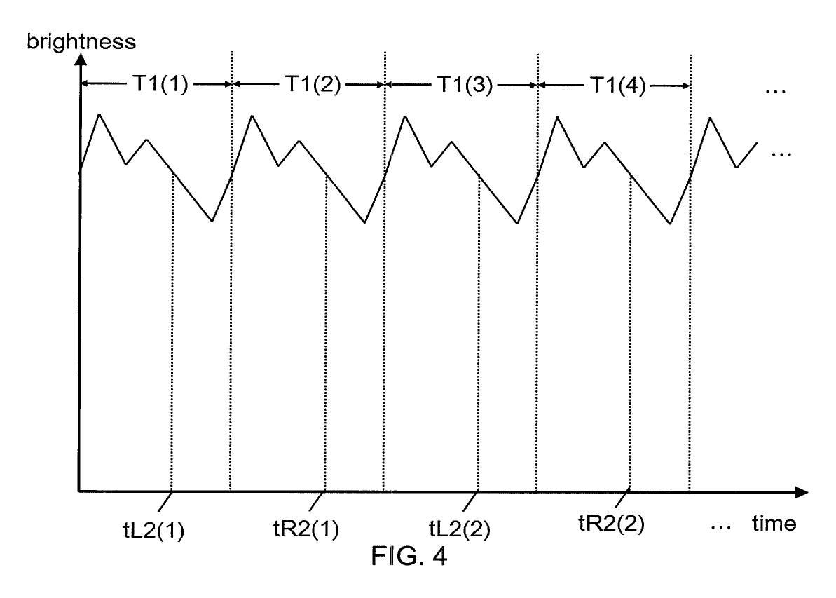

As show in FIG. 4, in another embodiment, the image control device 118 configures the display frequency of the display device 110 so that the viewer may perceive substantially the same brightness when observing the left image frames and the right image frames. For example, the image control device 118 or the image frame conversion device (not shown in FIG. 1) may convert the image frames of a 120 Hz display frequency into the image frames of a 100 Hz display frequency. Thus, the interval T1(n) for displaying an image frame is configured as 1/100 second. The period of the intervals tL2(n) and the period of the intervals tR2(n) are configured as 1/50 second, respectively. In another embodiment, the image control device 118 or the image frame conversion device may convert the image frames so as to present the image frames with a higher display frequency. In another embodiment, the image control device 118 may configures the display frequency of the display device accompanied with other adjustment methods mentioned above so that the viewer may perceive substantially the same brightness when observing the left image frames and the right image frames.

In another embodiment, the image control device 118 may adjust one or more light sources configured outside the display device 110 alone or in combination with other adjustment methods mentioned above so that the viewer may perceive substantially the same brightness when observing the left image frames and the right image frames.

The light source 112, the optical sensor 114, the interference sensor 116, and the image control device 118 may be configured inside and/or outside the display device 110, and may be realized with discrete circuits, integrated circuits, processors, software, other suitable hardware, or the collaboration of hardware and software. The components may be coupled through wired or wireless connections. The number of components, the relative position, and the connections in the description and in the drawings are illustrative only. The function blocks described herein may be realized with one or more components. For example, in one embodiment, the optical sensor 114 may be configured behind the lenses 192 and 194 of the glasses 190 for accurately detecting the brightness perceived by the viewer. Other components, e.g., the image control device 118, may be configured outside the display device 110 or in the glasses 190.

The 3D images described herein may be realized with any suitable stereoscopic technology. Although the 3D display devices are described in this disclosure as examples, the embodiments may also be applicable to the applications which the brightness of the images or the ambient light need to be adjusted because the left eye and the right eye of the viewer observe the images at different intervals.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An image control device for coupling with a display device, wherein the display device may cooperate with a pair of glasses, comprising:
a first input end for receiving light-sensing signals from one or more sensors;
a second input end for coupling with an image frame conversion device; and
a signal processing device for configuring the image frame conversion device to convert a plurality of first image data of a first display frequency into a plurality of second image data of a second display frequency according to the light-sensing signals, and for configure the display device to sequentially display a first, a second, a third, and a fourth image frames of the second image data with the second display frequency;
wherein a first lens of the glasses is non-opaque when the display device presents the first and the third image frames respectively in a first period and in a third period, and a second lens of the glasses is non-opaque when the display device presents the second and the fourth image frames respectively in a second period and in a fourth period.

2. The image control device of claim 1, wherein the signal processing device adjusts the brightness of a light source of the display device when the light-sensing signals of the first, the second, the third, and/or the fourth periods are lower than a first predetermined value, and/or when the first, the second, the third, and/or the fourth periods are greater than a second predetermined value.

3. The image control device of claim 1, wherein the signal processing device adjusts the transparency of the first lens and/or the second lens according the light-sensing signals.

4. The image control device of claim 2, wherein the signal processing device adjusts the transparency of the first lens and/or the second lens according the light-sensing signals.

5. The image control device of claim 1, wherein the signal processing device adjusts the duration of the first period and/or the duration of the second period according to the light-sensing signals.

6. The image control device of claim 2, wherein the signal processing device adjusts the duration of the first period and/or the duration of the second period according to the light-sensing signals.

7. An image control device for coupling with a display device, wherein the display device may cooperate with a pair of glasses for sequentially displaying a first, a second, a third, and a fourth image frames, a first lens of the glasses is non-opaque when the display device presents the first and the third image frames respectively in a first period and in a third period, and a second lens of the glasses is non-opaque when the display device presents the second and the fourth image frames respectively in a second period and in a fourth period, comprising:
an input end for receiving light-sensing signals from one or more sensors; and
a signal processing device for configuring the first lens and/or the second lens according to the light-sensing signals so that a first interval between the first period and the second period and a second interval between the second period and the third period are different.

8. The image control device of claim 7, wherein the signal processing device adjusts the brightness of a light source of the display device when the light-sensing signals of the first, the second, the third, and/or the fourth periods are lower than a first predetermined value, and/or when the first, the second, the third, and/or the fourth periods are greater than a second predetermined value.

9. The image control device of claim 7, wherein the signal processing device adjusts the transparency of the first lens and/or the second lens according the light-sensing signals.

10. The image control device of claim 8, wherein the signal processing device adjusts the transparency of the first lens and/or the second lens according the light-sensing signals.

11. The image control device of claim 7, wherein the signal processing device adjusts the duration of the first period and/or the second period according to the light-sensing signals.

12. The image control device of claim 8, wherein the signal processing device adjusts the duration of the first period and/or the second period according to the light-sensing signals.

13. An image control device for coupling with a display device, wherein the display device may cooperate with a pair of glasses for sequentially displaying a first and a second image frames, a first lens of the glasses is non-opaque when the display device presents the first image frame in a first period, and a second lens of the glasses is non-opaque when the display device presents the second image frame in a second period, comprising:
an input end for receiving light-sensing signals from one or more sensors; and
a signal processing device for configuring the brightness of a light source of the display device according to the light-sensing signals so that the brightness of the light source in the first period is different from the brightness of the light source in the second period.

14. The image control device of claim 13, wherein the signal processing device adjusts the brightness of the light source when the light-sensing signals of the first and the second periods are lower than a first predetermined value, and/or when the first and the second periods are greater than a second predetermined value.

15. The image control device of claim 13, wherein the signal processing device adjusts the transparency of the first lens and/or the second lens according the light-sensing signals.

16. The image control device of claim 14, wherein the signal processing device adjusts the transparency of the first lens and/or the second lens according the light-sensing signals.

17. The image control device of claim 13, wherein the signal processing device adjusts the duration of the first period and/or the second period according to the light-sensing signals.

18. The image control device of claim 14, wherein the signal processing device adjusts the duration of the first period and/or the second period according to the light-sensing signals.
